(19) United States
(12) Patent Application Publication
(10) Pub. No.: US 2026/0086255 A1
(43) Pub. Date: Mar. 26, 2026

(54) DISTRIBUTED OPTICAL FIBER MONITORING SYSTEM FOR FAILURE MONITORING OF DEEP ROCK MASS

(71) Applicant: SICHUAN UNIVERSITY, Chengdu (CN)

(72) Inventors: Jianfeng LIU, Chengdu (CN); Yang WU, Chengdu (CN); Fujun XUE, Chengdu (CN); Yifan TANG, Chengdu (CN); Zhenxing JI, Chengdu (CN); Jinbing WEI, Chengdu (CN); Xiangchao SHI, Chengdu (CN); Liangfu XIE, Chengdu (CN); Yongming YANG, Chengdu (CN); Mingbo CHI, Chengdu (CN); Jianhong KANG, Chengdu (CN)

(73) Assignee: SICHUAN UNIVERSITY, Chengdu (CN)

(21) Appl. No.: 19/332,089

(22) Filed: Sep. 18, 2025

(30) Foreign Application Priority Data
Sep. 20, 2024 (CN) 202411312320.0

(51) Int. Cl. G01V 1/22

(52) U.S. Cl. CPC G01V 1/226

(57) ABSTRACT

A distributed optical fiber monitoring system for failure monitoring of a deep rock mass is applied to an underground chamber and can simultaneously monitor failure signals in axial and radial directions of the underground chamber, facilitating three-dimensional positioning of a failure source. The distributed optical fiber monitoring system includes a first optical fiber and a second optical fiber. The first optical fiber is deployed on a chamber wall along the axial direction of the underground chamber to monitor the failure signal distributed along the axial direction of the underground chamber. The second optical fiber mainly includes a peripheral optical fiber segment and a direction-changing transition segment. The peripheral optical fiber segment is deployed on the chamber wall along a cross-sectional profile of the chamber wall to monitor the failure signal distributed along the radial direction of the underground chamber.

### CROSS REFERENCE TO THE RELATED APPLICATIONS

This application is based upon and claims priority to Chinese Patent Application No. 202411312320.0, filed on Sep. 20, 2024, the entire contents of which are incorporated herein by reference.

### TECHNICAL FIELD

The present disclosure belongs to the field of monitoring devices, and specifically relates to a distributed optical fiber monitoring system for failure monitoring of a deep rock mass.

### BACKGROUND

Engineering excavation disturbances can alter the original state of a rock mass, including but not limited to changes in temperature, strain, and rock failure. These changes directly affect both engineering construction and long-term operation safety. Therefore, effectively monitoring and predicting the changing state of the rock mass is an important measure for ensuring engineering safety. The changes in the state of the rock mass encompass not only deformation and rock mass failure caused by stress field adjustments, such as surrounding rock collapse and rock burst, but also alterations in the temperature field, as seen in cases of water inrush and geological disposal of high-level radioactive waste. As one of the typical representatives of rock mass failure disasters, rock burst is a highly dangerous dynamic disaster. However, there is still a lack of equipment and analysis techniques for effectively monitoring and predicting the rock bursts.

The rock burst is caused by the sudden and violent release of accumulated elastic deformation potential energy within the rock mass due to external disturbances. Before a rock failure occurs, only internal deterioration of the rock mass takes place, generating minor vibrations and acoustic emissions imperceptible to the human ear. Most rock failures occur within 24 hours after the rock mass is excavated, typically lasting 1 to 2 months, and in some cases persisting for over a year. Severe instances can generate events equivalent to magnitude 4 to 6 earthquakes, with intensities reaching VII to VIII on the intensity scale. Therefore, rock failures can be monitored and predicted based on characteristics such as vibrations and acoustic emissions generated before and during occurrence of the rock failures. After the source location, magnitude, and potential duration of the rock failure are identified, corresponding preventive measures can be taken to minimize or eliminate casualties and property losses caused by the rock failure.

At present, field measurement and prediction of rock bursts mainly involve predicting the location and possibility of rock bursts during construction through field monitoring methods such as the microseismic (MS) method, acoustic emission (AE) method, drilling cuttings method, electromagnetic radiation (EMR) method, and distributed optical fiber monitoring method. Among them, the distributed optical fiber monitoring method monitors failure signals such as vibrations and acoustic emissions generated before and during occurrence of the rock mass failure at monitoring points through optical fibers. It has problems such as dispersed monitoring signals, difficulty in deployment, and low survivability in complex geological environments.

For example, Chinese utility model patent CN212003266U discloses a rock burst monitoring system based on distributed optical fiber sensing. In the disclosure, multiple armored optical cables are deployed and fixed along top and side supporting rock masses or supporting walls of a tunnel being excavated or completed or on working faces being excavated along a mountain or ore body. One end of each of the armored optical cables is connected to a multi-channel wide-band distributed optical fiber acoustic and strain sensing modulation and demodulation system. The multi-channel wide-band distributed optical fiber acoustic and strain sensing modulation and demodulation system is connected to a real-time data recording and processing computer. Since deeply buried tunnel chambers are generally excavated by blasting, the surrounding rock of the chamber wall has large undulations. Therefore, if optical fibers are used for rock burst monitoring, the optical fiber and the surrounding rock cannot be well coupled with each other. Moreover, to couple the optical fiber with the surrounding rock, the optical fiber often needs to be bent to a large extent at the monitoring point, greatly reducing the survivability of the optical fiber. In addition, the linear deployment method along the axial direction of the tunnel is not suitable for facilities with multiple intersecting chambers, such as deep underground laboratories and underground factories. Because optical fibers are sensitive to deformation along their axis, this linear deployment method can often only monitor failure signals distributed along the axial direction of the tunnel, and cannot monitor failure signals in other directions, making it hard to achieve three-dimensional positioning of the failure source.

Therefore, there is an urgent need in the art for a distributed optical fiber monitoring system for failure monitoring of a deep rock mass to solve the above technical problems.

### SUMMARY

The present disclosure is intended to solve at least one of the technical problems existing in the prior art. For this purpose, the present disclosure provides a distributed optical fiber monitoring system for failure monitoring of a deep rock mass. The present disclosure is applied to an underground chamber and can simultaneously monitor failure signals in axial and radial directions of the underground chamber, facilitating three-dimensional positioning of a failure source.

In order to solve the technical problem, the present disclosure adopts the following technical solution. A distributed optical fiber monitoring system for failure monitoring of a deep rock mass, including: a first optical fiber, where the first optical fiber is deployed on a chamber wall of an underground chamber along an axial direction of the underground chamber;
the distributed optical fiber monitoring system further includes a second optical fiber; and the second optical fiber includes a peripheral optical fiber segment and a direction-changing transition segment;
the peripheral optical fiber segment is deployed on the chamber wall along a cross-sectional profile of the chamber wall; and
there are at least two peripheral optical fiber segments deployed at an interval along the axial direction of the underground chamber; and the peripheral optical fiber segments are sequentially connected end to end through the direction-changing transition segment to enable a continuous optical path for the second optical fiber.

Furthermore, the chamber wall includes a left chamber wall, a top chamber wall, and a right chamber wall; and
there are more than three first optical fibers, including: at least one first optical fiber deployed on the left chamber wall, at least one first optical fiber deployed on the top chamber wall, and at least one first optical fiber deployed on the right chamber wall.

Furthermore, there are six first optical fibers, where
one of the six first optical fibers is deployed on the left chamber wall and located at a position of a ⅓ height of the left chamber wall;
one of the six first optical fibers is deployed on the left chamber wall and located at a position of a ⅔ height of the left chamber wall;
one of the six first optical fibers is deployed on the top chamber wall and located at a position of a ⅓ arc length of the top chamber wall;
one of the six first optical fibers is deployed on the top chamber wall and located at a position of a ⅔ arc length of the top chamber wall;
one of the six first optical fibers is deployed on the right chamber wall and located at a position of a ⅓ height of the right chamber wall; and
one of the six first optical fibers is deployed on the right chamber wall and located at a position of a ⅔ height of the right chamber wall.

Furthermore, the distributed optical fiber monitoring system further includes: a multi-channel optical fiber sensing conditioner and a data processing terminal, where
one end of the first optical fiber and one end of the second optical fiber each are configured to extend to an excavation face of the underground chamber and each are provided with a light extinction device;
the other end of the first optical fiber and the other end of the second optical fiber each are optically connected to the multi-channel optical fiber sensing conditioner through a lead-out optical fiber deployed along a wall surface of a shaft; and
the multi-channel optical fiber sensing conditioner is communicatively connected to the data processing terminal.

Furthermore, the first optical fibers and/or the second optical fiber are optically connected to an integrated optical fiber sensor configured to acquire a failure signal in a key monitoring area;
the integrated optical fiber sensor includes a deformable body and a third optical fiber; and the third optical fiber includes a first optical fiber segment and a second optical fiber segment that communicate with each other;
the first optical fiber segment is disposed on a circumferential wall of the deformable body, and is spirally wound around an axial direction of the deformable body for at least one circle to form a first optical fiber coil; and
the second optical fiber segment includes a straight segment disposed on the circumferential wall of the deformable body along the axial direction of the deformable body; there are at least two straight segments uniformly distributed around a circumferential direction of the deformable body; and the straight segments are sequentially connected end to end through an arc-shaped direction-changing segment to form a second optical fiber coil with a continuous optical path.

Furthermore, the integrated optical fiber sensor further includes a vibration transmission assembly; and
the vibration transmission assembly is disposed at a bottom of the deformable body, and is configured to transmit a vibration generated by a rock mass failure to the deformable body.

Furthermore, the vibration transmission assembly includes a rigid transmission plate and a rigid vibration ball;
one side surface of the rigid transmission plate is attached to a bottom surface of the deformable body; and
the rigid vibration ball is disposed on the other side surface of the rigid transmission plate; and there are at least three rigid vibration balls distributed in a circular array with an extension line of an axis of the deformable body as an array centerline.

Furthermore, the integrated optical fiber sensor further includes a protective housing, an optical fiber guide tube, and a rock mass coupling component;
the deformable body is cylindrical;
the protective housing is covered outside the deformable body; and a bottom of the vibration transmission assembly is at least partially exposed outside the protective housing;
the optical fiber guide tube includes an inner guide tube and an outer guide tube; the inner guide tube is inserted into the protective housing along the axial direction of the deformable body; and the outer guide tube is disposed outside the protective housing, and an opening of a partial tube segment of the outer guide tube is connected to an opening at an end of the inner guide tube;
the third optical fiber further includes an incoming optical fiber segment and an outgoing optical fiber segment; a tail end of the incoming optical fiber segment enters the optical fiber guide tube from an opening at one end of the outer guide tube, exits from a side of the inner guide tube, and is connected to a head end of the first optical fiber segment; and a head end of the outgoing optical fiber segment is connected to a tail end of the second optical fiber segment, and a tail end of the outgoing optical fiber segment enters the optical fiber guide tube from the side of the inner guide tube and exits from an opening at the other end of the outer guide tube; and
the rock mass coupling component is disposed at the bottom of the vibration transmission assembly, and is configured to be coupled with a rock mass.

Furthermore, the rock mass coupling component is a coupling cone; and a bottom surface of the coupling cone is connected to the bottom of the vibration transmission assembly.

Furthermore, the rock mass coupling component includes a coupling base and a coupling connector;
one side surface of the coupling base is attached to the bottom of the vibration transmission assembly;
the coupling connector is disposed on the coupling base, and at least a part of a connection portion of the coupling connector penetrates from the other side surface of the coupling base; and
there are at least three coupling connectors distributed in a circular array with an extension line of an axis of the deformable body as an array centerline.

The present disclosure has the following beneficial effects:

(1) The present disclosure provides a distributed optical fiber monitoring system for failure monitoring of a deep rock mass. The distributed optical fiber monitoring system is deployed in an underground chamber to monitor failure signals such as vibrations and acoustic emissions generated before and during a rock mass failure. The first optical fibers are deployed on a chamber wall of the underground chamber along an axial direction of the underground chamber to monitor a failure signal distributed along the axial direction of the underground chamber. The second optical fiber mainly includes a peripheral optical fiber segment and a direction-changing transition segment. The peripheral optical fiber segment is deployed on the chamber wall along a cross-sectional profile of the chamber wall to monitor a failure signal distributed along a radial direction of the underground chamber. The distributed optical fiber monitoring system can simultaneously monitor failure signals in the axial and radial directions of the underground chamber, achieving spatial monitoring of the underground chamber and facilitating accurate three-dimensional positioning of the failure source.

(2) The distributed optical fiber monitoring system further includes a multi-channel optical fiber sensing conditioner and a data processing terminal. The multi-channel optical fiber sensing conditioner is configured to simultaneously acquire strain signals measured by the first optical fiber and the second optical fiber and send the strain signals to the data processing terminal. The data processing terminal is configured to analyze and process the strain signals and provide real-time feedback of the energy magnitude and location distribution of failure events occurring in the excavation of the underground chamber. Therefore, based on the location and energy information, areas where disaster events such as rock bursts or collapses may occur can be predicted in advance, thereby guiding staff to take preventive measures and disposal in advance, minimizing casualties and property losses caused by disaster events.

(3) The first optical fiber and/or the second optical fiber are connected to integrated optical fiber sensors. The integrated optical fiber sensors are configured to monitor key monitoring areas in the underground chamber, improving the monitoring effect of the distributed optical fiber monitoring system. The deformable body of the integrated optical fiber sensor deforms when sensing failure signals, causing the first optical fiber coil and the second optical fiber coil on the circumferential wall of the deformable body to deform, thereby monitoring the failure signals. Since the optical fiber is sensitive to failure signals along its axial direction, the first optical fiber coil, which is wound around the axial direction of the deformable body in a spiral shape for at least one circle, can effectively monitor longitudinal and transverse strains perpendicular to the axial direction of the deformable body caused by vibrations. The second optical fiber coil, which has two or more straight segments uniformly distributed around the circumference of the deformable body and arranged along the axial direction of the deformable body, is configured to effectively monitor strains along the axial direction of the deformable body caused by vibrations. Therefore, the integrated optical fiber sensor can simultaneously acquire components of the failure signals in three directions, X, Y, and Z, and has a good monitoring effect on failure signals such as vibrations and acoustic emissions generated before and during the failure.

(4) The monitoring method implemented based on the distributed optical fiber monitoring system is configured to synchronously acquire the three-dimensional distribution of the deformation field and the temperature field of the rock mass of the monitored chamber, truly reflecting differences in the deformation field state and the temperature field at different parts of the chamber in terms of space morphology.

Other technical effects brought about or directly produced by the technical features of the present disclosure will be elaborated in the subsequent detailed description section.

### BRIEF DESCRIPTION OF THE DRAWINGS

FIG. 1 is a schematic diagram of an implementation structure of the present disclosure;

FIG. 2 is a schematic diagram of an implementation structure of an embodiment of an integrated optical fiber sensor in the present disclosure;

FIG. 3 is an analysis diagram of a failure signal monitored by a wound optical fiber;

FIG. 4 is a schematic diagram of the wound optical fiber shown in FIG. 3 in an unfolded state;

FIG. 5 is a relationship diagram between an n-axis of a local coordinate system and a global coordinate system shown in FIG. 3;

FIG. 6 is a schematic diagram of an implementation structure of another embodiment of the integrated optical fiber sensor in the present disclosure; and

FIG. 7 is a schematic diagram of an implementation structure of still another embodiment of the integrated optical fiber sensor in the present disclosure.

Reference Numerals: 1. underground chamber; 11. chamber wall; 2. first optical fiber; 3. second optical fiber; 31. peripheral optical fiber segment; 32. direction-changing transition segment; 4. multi-channel optical fiber sensing conditioner; 5. data processing terminal; 100. deformable body; 210. incoming optical fiber segment; 220. first optical fiber coil; 230. second optical fiber coil; 231. straight segment; 232. arc-shaped direction-changing segment; 240. outgoing optical fiber segment; 300. vibration transmission assembly; 310. rigid transmission plate; 320. rigid vibration ball; 400. protective housing; 500. optical fiber guide tube; 510. inner guide tube; 520. outer guide tube; 600. coupling cone; 710. coupling base; and 720. coupling connector.

### DETAILED DESCRIPTION OF THE EMBODIMENTS

The present disclosure will be further described in detail below in conjunction with the drawings and embodiments. The same reference numerals in the drawings indicate elements with the same or similar functions. Although various aspects of the embodiments are shown in the drawings, unless otherwise noted, the drawings are not necessarily drawn to scale.

In the description of the present disclosure, it should be understood that terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “head”, “tail”, “clockwise”, “counterclockwise”, “axial”, “radial”, and “circumferential” indicate orientations or positional relationships, as well as dimensional relationships based on the drawings. They are used merely for the purpose of facilitating the description of the present disclosure, and do not indicate or imply that the referred apparatus or components must have a specific orientation or be constructed and operated in a specific orientation. Therefore, they should not be construed as limitations on the present disclosure.

The term “approximately” or “about,” when used to describe a numerical range, generally indicates an error within +10%. For example, “approximately 100 mm” typically refers to a range of 90-110 mm. The term “a plurality of,” when used to indicate quantity, generally refers to a quantity of three or more. For instance, “a plurality of” usually means three or more. The expression “mainly include” means that the structure may also include components not explicitly recited in the statement. The term “and/or” merely describes associations between associated objects, and it indicates three types of relationships. For example, A and/or B may indicate that A exists alone, A and B coexist, and B exists alone. The term “communicative connection” refers to the establishment of communication between connected devices through signal transmission and interaction, which can be classified into wired connections and wireless connections. Wired connections typically include connections via cables, optical fibers, etc., and wireless connections typically include radio communication, Bluetooth connection, infrared connection, near-field communication (NFC) connection, etc. Moreover, the terms “first”, “second”, and “third” are used only for the purpose of description, and are not intended to indicate or imply relative importance.

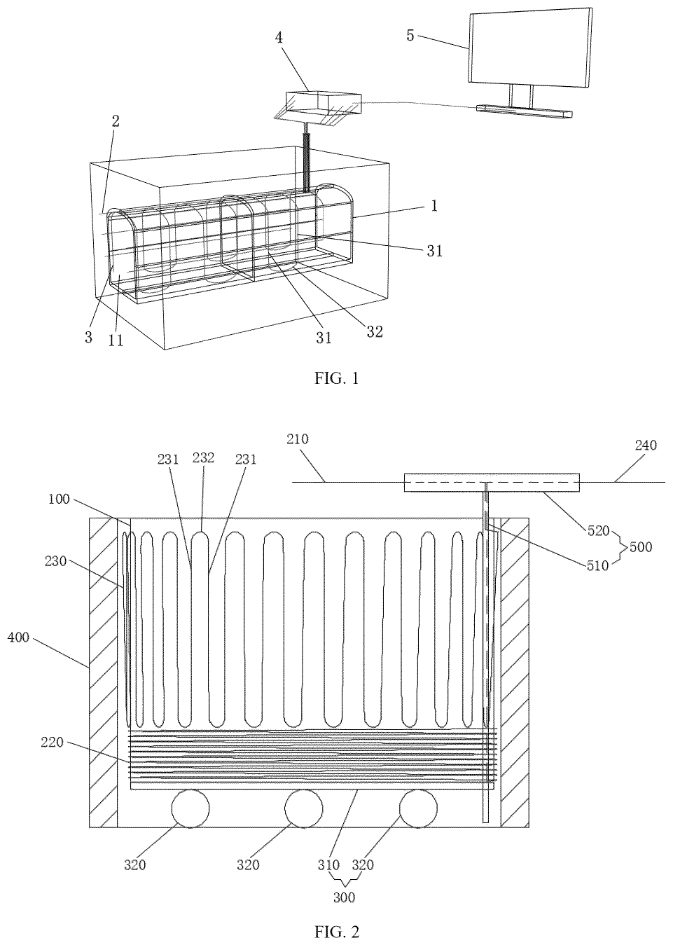

As shown in FIG. 1, a distributed optical fiber monitoring system for failure monitoring of a deep rock mass includes first optical fiber 2 and second optical fiber 3.

The first optical fiber 2 is deployed on chamber wall 11 of underground chamber 1 along an axial direction of the underground chamber 1 to monitor failure signals distributed along the axial direction of the underground chamber 1. The first optical fiber 2 is generally fixed to the chamber wall 11 by a binder such as cement or by a fastener such as a cable clip. The number of the first optical fibers 2 is generally selected according to monitoring needs, and usually there are multiple first optical fibers deployed according to the resolution requirement of the optical fiber.

The second optical fiber 3 is fixed to the chamber wall 11 in the same way as the first optical fiber 2. The second optical fiber 3 includes peripheral optical fiber segment 31 and direction-changing transition segment 32.

The peripheral optical fiber segment 31 is deployed on the chamber wall 11 along a cross-sectional profile of the chamber wall to monitor failure signals distributed along a radial direction of the underground chamber 1. The peripheral optical fiber segment 31 is generally perpendicular to the axial direction of the underground chamber 1, and is deployed in sequence along a height direction of a left chamber wall, an arc length direction of a top chamber wall, and a height direction of a right chamber wall. Since the top chamber wall is arc-shaped, when the peripheral optical fiber segment 31 transitions from the left chamber wall to the top chamber wall and from the top chamber wall to the right chamber wall, an arc radius for bending is greater than 20 times a diameter of a bare optical fiber.

There are at least two peripheral optical fiber segments 31 deployed at an interval along the axial direction of the underground chamber 1. The peripheral optical fiber segments 31 are connected end to end in sequence through the direction-changing transition segment 32, such that an optical path of the second optical fiber 3 is continuous. A larger quantity of the peripheral optical fiber segments 31 indicates a higher monitoring accuracy, but this will lead to signal acquisition redundancy. Therefore, the specific quantity of the peripheral optical fiber segments 31 is usually determined comprehensively according to factors such as monitoring effect requirement, a minimum arc radius of the direction-changing transition segment 32, manufacturing cost, and manufacturing difficulty. The direction-changing transition segment 32 is usually smoothly transitionally connected to the peripheral optical fiber segment 31, and the arc radius of the direction-changing transition segment 32 should avoid affecting signal transmission of the optical fiber. Usually, an arc radius of the direction-changing transition segment 32 is required to be greater than 20 times the diameter of the bare optical fiber.

The distributed optical fiber monitoring system is mainly deployed in the underground chamber 1 to monitor failure signals such as vibrations and acoustic emissions generated before and during a rock mass failure. It can simultaneously monitor failure signals in the axial and radial directions of the underground chamber 1, achieving spatial monitoring of the underground chamber and facilitating accurate three-dimensional positioning of the failure location.

Usually, to acquire high-precision failure signals, the spacing between optical fibers is equal or approximately equal to the resolution of the optical fibers. The resolution is preset according to the monitoring effect requirement. The spacing between the optical fibers refers to spacing between each two adjacent ones of the multiple first optical fibers 2 and/or spacing between each two adjacent peripheral optical fiber segments 31. If the spacing between the optical fibers is too large, the following shortcomings exist: incomplete acquired signals, low monitoring accuracy, and increased data sparsity. If the spacing between the optical fibers is too small, the following shortcomings exist: redundant signal acquisition, waste of resources, and more computing and storage resources required to process and store the redundant information. Therefore, the spacing between the optical fibers is usually limited to 1 to 5 m.

Specifically, the second optical fiber 3 is deployed on the chamber wall 11 as follows. The second optical fiber 3 is vertically deployed on a wall surface of the left chamber wall by cement or a cable clip. When the second optical fiber reaches a top of the left chamber wall, it is bent upward in an arc shape with a radius greater than 20 times the diameter of the bare optical fiber. Then the second optical fiber continues to extend upward along the top of the left chamber wall and transitions to the top chamber wall while closely adhering to the wall surface. The second optical fiber is bent and deployed along the top chamber wall perpendicular to the axial direction of the underground chamber 1 until it extends to a top of the right chamber wall. The second optical fiber is deployed downward along a wall surface of the right chamber wall, and extends to a bottom of the right chamber wall, forming one peripheral optical fiber segment 31. The second optical fiber is bent to form the direction-changing transition segment 32 that changes a direction of the second optical fiber 3. Then another peripheral optical fiber segment 31 is deployed with the bottom of the right chamber wall as a start point and a bottom of the left chamber wall as an end point. This process is repeated to bend the second optical fiber 3 until the second optical fiber is deployed to an excavation face. The spacing between any two adjacent peripheral optical fiber segments 31 is less than or equal to the resolution of the optical fiber. Taking the resolution set to 2 m as an example, the spacing between any two adjacent peripheral optical fiber segments 31 is 2 m.

The first optical fibers 2 and the second optical fiber 3 of the distributed optical fiber monitoring system are generally not deployed on a bottom surface of the underground chamber 1 to prevent construction disturbances from reducing the survivability of the optical fibers and to avoid acquiring too many construction noise signals.

To improve the monitoring effect, as shown in FIG. 1, in some implementations of the present disclosure, the chamber wall 11 includes the left chamber wall, the top chamber wall, and the right chamber wall. There are more than three first optical fibers 2, including: at least one first optical fiber deployed on the left chamber wall, at least one first optical fiber deployed on the top chamber wall, and at least one first optical fiber deployed on the right chamber wall.

In some implementations of the present disclosure, the first optical fibers 2 and the second optical fiber 3 are armored optical fibers. The armored optical fibers enhance the survivability of the optical fibers in complex geological environments, and their armors are usually made of corrosion-resistant and anti-aging materials, preferably made of rubber.

As shown in FIG. 1, in some implementations of the present disclosure, there are six first optical fibers 2. Specifically, one of the six first optical fibers 2 is deployed on the left chamber wall and at a position of a ⅓ height of the left chamber wall. One of the six first optical fibers 2 is deployed on the left chamber wall and at a position of a ⅔ height of the left chamber wall. One of the six first optical fibers 2 is deployed on the top chamber wall and at a position of a ⅓ arc length of the top chamber wall. One of the six first optical fibers 2 is deployed on the top chamber wall and at a position of a ⅔ arc length of the top chamber wall. One of the six first optical fibers 2 is deployed on the right chamber wall and at a position of a ⅓ height of the right chamber wall. One of the six first optical fibers 2 is deployed on the right chamber wall and at a position of a ⅔ height of the right chamber wall. Deploying the first optical fibers 2 uniformly in this way improves the monitoring accuracy of the optical fiber signals. There are two first optical fibers 2 deployed on the same chamber wall surface, and the signal data monitored by the two first optical fibers 2 can complement each other and be cross-verified. Taking the underground chamber 1 with a height of 6 m as an example, to monitor failure signals with high precision, the first optical fibers 2 are deployed as described above, and the resolution of the optical fibers is set to about 2 m.

As shown in FIG. 1, in some implementations of the present disclosure, the distributed optical fiber monitoring system further includes multi-channel optical fiber sensing conditioner 4 and data processing terminal 5.

One end of the first optical fiber 2 and one end of the second optical fiber 3 each are configured to extend to an excavation face of the underground chamber 1 and each are provided with a light extinction device. The light extinction device is configured to eliminate reflection signals from ends of the first optical fibers 2 and the second optical fiber 3 close to the excavation face.

The other end of the first optical fiber 2 and the other end of the second optical fiber 3 each are optically connected to the multi-channel optical fiber sensing conditioner 4 through a lead-out optical fiber that can be deployed along a wall surface of a shaft.

The multi-channel optical fiber sensing conditioner 4 is configured to simultaneously acquire strain signals measured by the first optical fibers 2 and the second optical fiber 3. There can be various multi-channel optical fiber sensing conditioners 4, which are preferably quantitative acoustic data acquisition system based on optical phase and amplitude demodulation developed by FEBUS Optics (France), model: TV155. The multi-channel optical fiber sensing conditioner 4 is communicatively connected to the data processing terminal 5.

The data processing terminal 5 is configured to analyze and process the strain signals to provide real-time feedback of the energy magnitude and location distribution of failure events occurring in the excavation of the underground chamber 1. Areas where rock burst events may occur can be predicted in advance based on the location and energy information, thereby guiding staff to perform reinforcement treatment in advance, minimizing casualties and property losses caused by rock bursts. The data processing terminal 5 can be various devices, such as a smartphone, a tablet computer, a computer, or a server. The data processing terminal 5 can analyze and process the strain signals by various methods, for example, the method recorded in Document 1 (Song Guangdong. Research on Microseismic Signal Acquisition and Identification and Source Location Based on Optical Fiber Sensing [D]. China University of Mining and Technology (Beijing), 2019.) and Document 2 (Luo B, Trainor-Guitton W, Bozdağ E, et al. Horizontally Orthogonal Distributed Acoustic Sensing Array for Earthquake- and Ambient-Noise-based Multichannel Analysis of Surface Waves [J]. Geophysical Journal International, 2020, 222(3): 2147-2161.).

The distributed optical fiber monitoring system finds that local stress concentration occurs in the rock mass before a rock mass failure occurs in the monitored area, thereby inducing a microseismic event. The optical fibers deployed on the chamber wall 11 monitor seismic waves of microseismic signals. The microseismic signals are transmitted to the multi-channel optical fiber sensing conditioner 4 and are transmitted in real time to the data processing terminal 5. The data processing terminal 5 calculates the spatial coordinate position and occurrence time of the failure event by inverting differences in the first arrival times of P-waves and S-waves of the same microseismic signal at different monitoring points of the optical fiber. Meanwhile, based on the amplitude of the monitored failure signal, the energy magnitude of the microseismic event is determined. The data processing terminal 5 presents the information such as failure location and energy in real time to determine areas where rock bursts may occur. An early warning is issued in time such that staff can reinforce areas where rock bursts may occur.

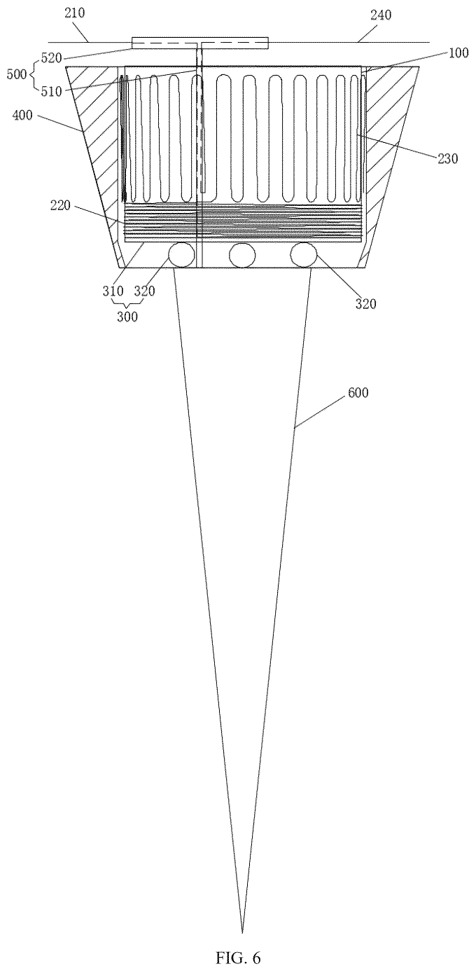

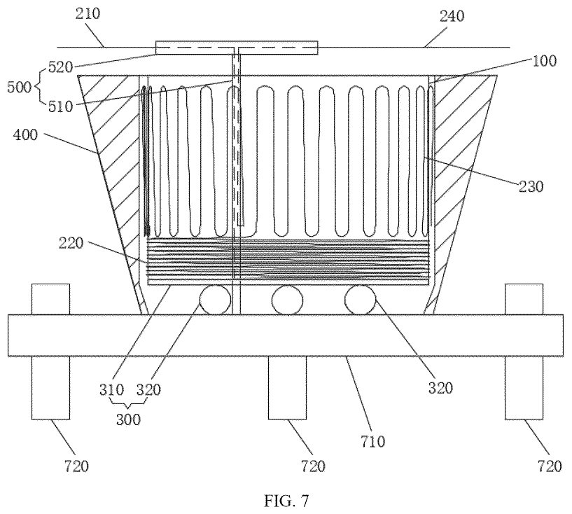

As shown in FIG. 2, FIG. 6, or FIG. 7, in some implementations of the present disclosure, the first optical fibers 2 and/or the second optical fiber 3 are optically connected to an integrated optical fiber sensor for acquiring failure signals in key monitoring areas. There may be one, two, or more integrated optical fiber sensors. The integrated optical fiber sensor is connected to the first optical fibers 2 and/or the second optical fiber 3. The specific segment position of the connected optical fiber is determined in advance according to actual needs. The signal acquired by each segment of the first optical fibers 2 and/or the second optical fiber 3 is displayed in real time on the data processing terminal 5 and can be retrieved. Therefore, when there are more than two integrated optical fiber sensors arranged, the position of the integrated optical fiber sensor that monitors the signal can be determined according to the deployment position of the integrated optical fiber sensor on the optical fiber. Thus, before formal monitoring, the position of the optical fiber is accurately calibrated. Specifically, first, the optical fiber is connected to the multi-channel optical fiber sensing conditioner 4. The length of a certain position of the optical fiber is measured, and that position is tapped. The vibration generated by the tapping is processed by the multi-channel optical fiber sensing conditioner 4, and the data processing terminal 5 highlights information such as the amplitude of the tapping position. Thus, the position can be calibrated on the data processing terminal 5 with the measured length.

Usually, key monitoring areas in the underground chamber 1 are determined according to construction requirements, generally including rock masses close to an entrance and exit of the underground chamber 1, areas with structural deformation in the underground chamber 1, rock layers with thin coverage in the underground chamber 1, areas with many fractures in the underground chamber 1, etc.

The integrated optical fiber sensor includes deformable body 100 and a third optical fiber. The third optical fiber includes a first optical fiber segment and a second optical fiber segment that communicate with each other.

The deformable body 100 is a component that produces elastic deformation under a load (such as vibration). The deformable body 100 is usually made of an elastic material, preferably made of rubber. The deformable body 100 is usually a regular columnar structure, preferably cylindrical, such that it deforms under a vibration in accordance with the vibration magnitude, vibration frequency, and vibration direction, thereby ensuring the monitoring effect.

The first optical fiber segment is disposed on a circumferential wall of the deformable body 100 and is wound around an axial direction of the deformable body 100 in a spiral shape for at least one circle, forming first optical fiber coil 220. The optical fiber can monitor failure signals along its axial direction, and each circle of the first optical fiber coil 220 is nearly perpendicular to the axial direction of the deformable body 100. Therefore, the first optical fiber coil 220 can effectively monitor longitudinal and transverse strains perpendicular to the axial direction of the deformable body 100 caused by vibrations. A larger circle quantity of the first optical fiber coil 220 leads to a smaller spacing between adjacent circles and a better monitoring effect. The specific circle quantity of the first optical fiber coil 220 and the spacing between adjacent circles are usually determined comprehensively according to factors such as actual monitoring effect requirements, manufacturing cost, manufacturing difficulty, and signal acquisition amount.

The second optical fiber segment includes straight segment 231 arranged on the circumferential wall along the axial direction of the deformable body 100. There are at least two straight segments 231 uniformly distributed around the circumference of the deformable body 100. The straight segments 231 are connected end to end in sequence through arc-shaped direction-changing segment 232, forming the second optical fiber coil 230 with a continuous optical path. The arc-shaped direction-changing segment 232 is usually smoothly transitionally connected to the straight segment 231, and an arc radius of the arc-shaped direction-changing segment 232 basically avoids affecting signal transmission of the optical fiber. The straight segments 231 effectively monitor strains along the axial direction of the deformable body 100 caused by vibrations. A larger quantity of the straight segments 231 indicates a higher monitoring accuracy, but this will lead to signal acquisition redundancy. Therefore, the specific quantity of the straight segments 231 is usually determined comprehensively according to factors such as monitoring effect requirements, the minimum arc radius of the arc-shaped direction-changing segment 232, manufacturing cost, manufacturing difficulty, and signal acquisition amount.

The integrated optical fiber sensor can simultaneously acquire components of the failure signals in three directions, X, Y, and Z, and has a good monitoring effect on failure signals such as vibrations and acoustic emissions generated before and during the rock mass failure. The theoretical basis for the optical fiber simultaneously monitoring components of the failure signals in three mutually perpendicular directions is as follows.

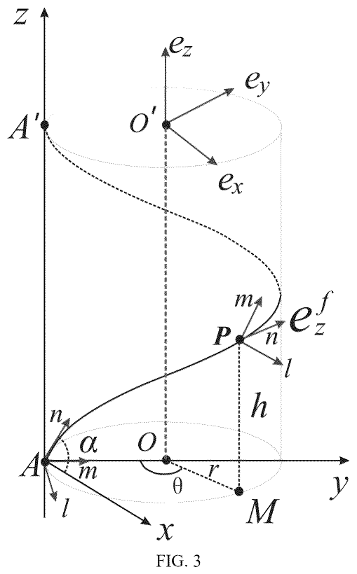

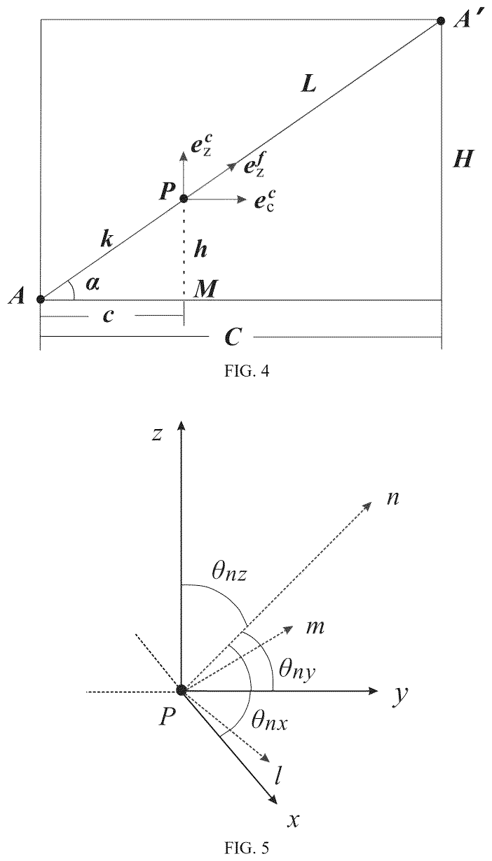

As shown in FIG. 3, FIG. 4, and FIG. 5, an analysis is performed on the failure signal components monitored by the optical fiber in wound configuration. In FIG. 3, point P denotes any position on the optical fiber, and α denotes a winding angle, which corresponds to an inclination angle of a front view projection of the first optical fiber coil 220 in the implementation shown in FIG. 2, or corresponds to an angle between the axial direction of the optical fiber at the point A shown in FIG. 3 and a circumferential tangent of the deformable body. AA′ denotes an optical fiber winding segment; eₓ, e_{y}, and e_{z} denote the strains of the X, Y, and Z components caused by the vibration at the position of the optical fiber, respectively. The strains are actual quantities calculated according to Eqs. 1 to 5. Since only the axial strain of the optical fiber can be actually acquired during the monitoring process, eₓ, e_{y}, and e_{z} are calculated based on the winding angle α and other parameters described below. In the equation, e^{f}_{z} denotes the axial strain of the optical fiber at the point P; P-lmn denotes a local coordinate system of the point P; the n direction denotes the axial direction of the optical fiber winding segment; θ denotes a rotation angle; and θₙₓ denotes an angle between an n-axis of the local coordinate system P-lmn and an x-axis of a global coordinate system. Similarly, θ_{ny} denotes an angle between the n-axis of the local coordinate system P-lmn and a y-axis of the global coordinate system, and θ_{nz} denotes an angle between the n-axis of the local coordinate system P-lmn and a z-axis of the global coordinate system.

From FIG. 3, FIG. 4, and FIG. 5, the relationship between the axial strain efz of the optical fiber at the point P and the three strain components can be derived as follows:

$${e}_{z}^{f} = {R}_{nx}^{2} {e}_{x} + {R}_{ny}^{2} {e}_{y} + {R}_{nz}^{2} {e}_{z} ; \qquad ( Eq . 1 )$$

The three coefficients Rₙₓ, R_{ny}, and R_{nz} that affect the axial strain of the optical fiber are respectively:

$$\{ \begin{matrix}{R}_{nx} = cos {θ}_{nx} \\ {R}_{ny} = cos {θ}_{ny} \\ {R}_{nz} = cos {θ}_{nz}\end{matrix} ; \qquad ( Eq . 2 )$$

The relationships between θₙₓ, θ_{ny}, θ_{nz} and the winding angle α are:

$$\{ \begin{matrix}{θ}_{nx} = ( α - \frac{π}{2} ) cos ( \frac{h}{r tan α} ) + \frac{π}{2} \\ {θ}_{ny} = ( α - \frac{π}{2} ) sin ( \frac{h}{r tan α} ) + \frac{π}{2} \\ {θ}_{nx} = \frac{π}{2} - α\end{matrix} ; \qquad ( Eq . 3 )$$

In the equation: Rₙₓ, R_{ny}, and R_{nz} respectively denote direction cosines between the n-axis and the x-, y-, and z-axes; and r denotes a winding radius of the optical fiber. In the implementation shown in FIG. 2, FIG. 6, or FIG. 7, r is equal to the radius of the deformable body 100. In addition, k denotes a length of an AP segment in the unfolded state of the wound optical fiber shown in FIG. 3; and h denotes a height of the point P in the unfolded state of the wound optical fiber.

Eq. 2 can be expressed in matrix form:

$${e}_{z}^{f} [ \begin{matrix}{R}_{nx}^{2} & {R}_{ny}^{2} & {R}_{nz}^{2}\end{matrix} ] \cdot {[ \begin{matrix}{e}_{x} & {e}_{y} & {e}_{z}\end{matrix} ]}^{T} ; \qquad ( Eq . 4 )$$

It can be written in a simple form as:

$$E = {GE}_{0} ; \qquad ( Eq . 5 )$$

In the equation, E denotes an axial strain matrix of the wound optical fiber; G denotes an expansion matrix composed of Rₙₓ, R_{ny}, and R_{nz}; and E₀ denotes a matrix composed of the actual three-component strains eₓ, e_{y}, and e_{z} of the wound optical fiber.

Based on Eqs. 1 to 5, the three-component strain E₀ at the optical fiber monitoring point is calculated according to the acquired axial strain E of the optical fiber. From Eqs. 1 to 5, it can be known that the three strain components generated by the failure signal received by the optical fiber are related to the winding angle α. When α increases, the e_{z} component increases, and the eₓ and e_{y} component strains decrease. When α decreases, the e_{z} component decreases, and the eₓ and e_{y} components increase. Therefore, in order to simultaneously acquire obvious monitoring signals of the three strain components, the present disclosure adopts two different winding methods to dispose the optical fiber segments on the deformable body 100. In one method, the first optical fiber segment is disposed on the circumferential wall of the deformable body 100 and wound around the axial direction of the deformable body 100 in a spiral shape for at least one circle, forming the first optical fiber coil 220. In the other method, the second optical fiber segment includes the straight segments 231 arranged on the circumferential wall along the axial direction of the deformable body 100. There are at least two straight segments 231 uniformly distributed around the circumference of the deformable body 100. The straight segments 231 are connected end to end in sequence through the arc-shaped direction-changing segment 232, forming the second optical fiber coil 230 with a continuous optical path. The winding angle α of the straight segment 231 is 90°, and the e_{z} component monitored reaches a maximum value. When the winding angle α of the first optical fiber coil 220 is close to 0°, the eₓ and e_{y} components monitored are close to the maximum value.

As shown in FIG. 2, FIG. 6, or FIG. 7, in some implementations of the present disclosure, the first optical fiber coil 220 is located at a lower side of the second optical fiber coil 230, and the first optical fiber coil 220 is wound from bottom to top. The design enables a compact structure, and ensures the optical path continuity of the third optical fiber to ensure monitoring sensitivity and accuracy. The winding angle α of the first optical fiber coil 220 is minimized. The winding length is determined according to actual measurement requirements and the size of the deformable body 100 and other factors, and is usually about 1 m.

In some implementations of the present disclosure, the integrated optical fiber sensor includes vibration transmission assembly 300. The vibration transmission assembly 300 is disposed at a bottom of the deformable body 100 and is configured to transmit vibrations generated by the rock mass failure to the deformable body 100 to improve monitoring sensitivity and accuracy. The vibration transmission assembly 300 can be of various types, and is usually made of rigid materials, preferably made of solid metal.

As shown in FIG. 2, FIG. 6, or FIG. 7, in some implementations of the present disclosure, the vibration transmission assembly 300 includes rigid transmission plate 310 and rigid vibration ball 320.

One side surface of the rigid transmission plate 310 is attached to a bottom surface of the deformable body 100 and is configured to uniformly transmit vibration energy to the deformable body 100. The rigid transmission plate 310 is usually a sheet-shaped component adapted to the bottom surface of the deformable body 100, and is usually made of rigid material, preferably made of metal material, such as a steel sheet. The rigid transmission plate 310 avoids direct contact between the rigid vibration ball 320 and the deformable body 100, preventing the consumption or weakening of vibration energy due to friction effects.

The rigid vibration ball 320 is disposed on the other side surface of the rigid transmission plate 310. There are at least three rigid vibration balls 320 distributed in a circular array with an extension line of the axis of the deformable body 100 as an array centerline. The rigid vibration balls 320 have regular shape and high dimensional accuracy, enabling precise vibration transmission. Moreover, the rigid vibration balls 320 have high hardness and rigidity, which can reduce energy loss during vibration transmission. In addition, the rigid vibration balls 320 distributed in a circular array can uniformly transmit failure signals. Therefore, when the rigid vibration balls 320 are subjected to external vibrations, only minor elastic deformation occurs, and they can quickly recover and generate vibration waves. These vibration waves propagate along the rigid vibration balls 320, thereby accurately and efficiently transmitting the failure signals to the rigid transmission plate 310. The rigid vibration balls 320 are usually made of rigid material, preferably made of metal material, such as steel.

In order to simplify the structure and ensure good vibration transmission effects, in some implementations of the present disclosure, preferably, there are three or four rigid vibration balls 320.

In order to effectively reduce the vibration energy loss at the connections between the rigid vibration balls 320 and the rigid transmission plate 310 and improve the connection effect, in some implementations of the present disclosure, preferably, the rigid vibration balls 320 and the rigid transmission plate 310 are in surface contact cooperation. That is, arc-shaped grooves are provided on the other side surface of the rigid transmission plate 310, such that the rigid vibration balls 320 are partially embedded in the arc-shaped grooves, forming an arc-shaped surface cooperation connection.

As shown in FIG. 2, FIG. 6, or FIG. 7, in some implementations of the present disclosure, the integrated optical fiber sensor further includes protective housing 400, optical fiber guide tube 500, and a rock mass coupling component.

The deformable body 100 is cylindrical.

The protective housing 400 is covered outside the deformable body 100. A bottom of the vibration transmission assembly 300 is at least partially exposed outside the protective housing 400. The protective housing 400 is mainly configured to protect the sensor components inside and reduce external interference to the integrated optical fiber sensor. The protective housing 400 is usually made of metal material. It can have various structures, and is usually a cylindrical or inverted frustum-shaped housing.

The optical fiber guide tube 500 includes inner guide tube 510 and outer guide tube 520. The inner guide tube 510 is inserted along the axial direction of the deformable body 100 into the protective housing 400. The outer guide tube 520 is disposed outside the protective housing 400, and an opening of a partial tube segment of the outer guide tube 520 is connected to an opening at an end of the inner guide tube 510.

The third optical fiber further includes incoming optical fiber segment 210 and outgoing optical fiber segment 240. A tail end of the incoming optical fiber segment 210 enters the optical fiber guide tube 500 from the opening at the one end of the outer guide tube 520, exits from a side of the inner guide tube 510, and is connected to a head end of the first optical fiber segment. A head end of the outgoing optical fiber segment 240 is connected to a tail end of the second optical fiber segment, and a tail end of the outgoing optical fiber segment 240 enters the optical fiber guide tube 500 from the side of the inner guide tube 510 and exits from an opening at the other end of the outer guide tube 520.

The rock mass coupling component is disposed at the bottom of the vibration transmission assembly 300 and is configured to couple with the rock mass. The rock mass coupling component can be of various types, for example: screw, bolt, anchor rod, connection seat, etc. The specific structure of the rock mass coupling component is selected according to the flatness of the chamber wall surface to ensure that the integrated optical fiber sensor is fully coupled with the chamber surrounding rock, thereby achieving an optimal monitoring effect.

The incoming optical fiber segment 210 and the outgoing optical fiber segment 240 are usually protected by an armor. The armor is usually made of corrosion-resistant and anti-aging materials, preferably made of rubber. The optical fiber guide tube 500 mainly includes the inner guide tube 510 and the outer guide tube 520, which are configured to guide the entrance and exit of the optical fiber, facilitate optical connection with other optical fibers and/or other integrated optical fiber sensors, and protect the optical fiber segment from external factors. The inner guide tube 510 is inserted along the axial direction of the deformable body 100 into the protective housing 400, making the entire integrated optical fiber sensor compact in structure and convenient for the mounting of the deformable body 100. The tail end of the incoming optical fiber segment 210 exits from the side of the inner guide tube 510, facilitating direct connection with the first optical fiber segment wound on the deformable body 100. The tail end of the outgoing optical fiber segment 240 enters the optical fiber guide tube 500 from the side of the inner guide tube 510, facilitating direct connection with the second optical fiber segment wound on the deformable body 100. The design reduces the optical fiber segments used for connection, thereby improving monitoring accuracy. The exposed connection ends of the incoming optical fiber segment 210 and the outgoing optical fiber segment 240 respectively exit from the openings at the two ends of the outer guide tube 520, facilitating the connection of the integrated optical fiber sensor with other optical components during use, and facilitating maintenance.

In some implementations of the present disclosure, a bottom of the protective housing 400 is open. The deformable body 100 is disposed in the protective housing 400 and fixed in a compressed state between an inner top surface of the protective housing 400 and the vibration transmission assembly 300. The exposed part of the vibration transmission assembly 300 is exposed through an opening at the bottom of the protective housing 400.

For the vibration transmission assembly 300 that mainly includes the rigid transmission plate 310 and the rigid vibration balls 320, when the failure signal is transmitted to the rigid vibration balls 320, the uniformly distributed rigid vibration balls 320 generate vibrations. Thus, the rigid vibration balls 320 uniformly distribute the failure signal to the deformable body 100 through the rigid transmission plate 310, thereby causing the deformable body 100 to generate uniform deformation corresponding to the failure signal. The deformation of the deformable body 100 causes the first optical fiber coil 220 and the second optical fiber coil 230 to deform, thereby causing changes in the optical signal inside the optical fiber, ultimately restoring the failure signal. In this way, the monitoring of the failure signal is achieved.

To further facilitate the use and maintenance of the integrated optical fiber sensor, as shown in FIG. 2, FIG. 6, or FIG. 7, in some implementations of the present disclosure, the inner guide tube 510 and the outer guide tube 520 are perpendicular to each other. A middle tube segment of the outer guide tube 520 is open and connected to the opening at the end of the inner guide tube 510, forming the optical fiber guide tube 500 in a “T”-shape.

As shown in FIG. 6, in some implementations of the present disclosure, the rock mass coupling component of the integrated optical fiber sensor is coupling cone 600. The coupling cone 600 is connected to the bottom of the vibration transmission assembly 300 through a bottom surface of the coupling cone. The coupling cone 600 has a conical structure, and its tip facilitates insertion into the chamber surrounding rock, enabling full coupling with the chamber surrounding rock to effectively transmit failure signals. When the failure signal is transmitted to the coupling cone 600, it causes the vibration transmission assembly 300 to generate vibrations. Therefore, the integrated optical fiber sensor is particularly suitable for situations where the chamber wall surface has large fluctuations, for example, blast-excavated chambers.

To further improve the monitoring effect, as shown in FIG. 6, in some implementations of the present disclosure, the coupling cone 600 is kept coaxial with the deformable body 100.

As shown in FIG. 7, in some implementations of the present disclosure, the rock mass coupling component of the integrated optical fiber sensor includes coupling base 710 and coupling connector 720. One side surface of the coupling base 710 is attached to the bottom of the vibration transmission assembly 300. The coupling connector 720 is disposed on the coupling base 710, and at least a part of a connection portion of the coupling connector penetrates from the other side surface of the coupling base 710. There are at least three coupling connectors 720 distributed in a circular array with an extension line of an axis of the deformable body 100 as an array centerline. The integrated optical fiber sensor is disposed, supported, and vibration-transmitted through the coupling base 710, and the coupling connectors 720 are connected to the chamber surrounding rock to ensure full contact between the coupling base 710 and the rock mass, enhancing the transmission of failure signals. The coupling connectors 720 can be screws, bolts, etc. The integrated optical fiber sensor has good coupling effect with the surrounding rock, requires small drilling depth of the surrounding rock, and has low deployment difficulty, making it particularly suitable for chambers with flat wall surfaces, for example, chambers excavated by a full-face hard rock tunnel boring machine (TBM).

The distributed optical fiber monitoring system for failure monitoring of a deep rock mass provided by the present disclosure is applied to the underground chamber 1, which can monitor failure signals during construction and achieve failure source localization and source energy intensity acquisition. The distributed optical fiber monitoring system has advantages such as simple deployment, long-distance monitoring, high sensitivity, large capacity, low cost, and all-weather, full-space acoustic/vibration perception, etc. The distributed optical fiber monitoring system overcomes problems of a single bare optical fiber such as dispersed monitoring signals, difficulty in deployment, and low survivability in complex geological environments, and can be used in complex deep burial environments. The distributed optical fiber monitoring system can effectively monitor failure signals such as vibrations and acoustic emissions generated before and during failure occurrence, and can prevent and monitor rock mass failure generated during the excavation of deep-buried high-stress underground chamber engineering, ensuring the safe and smooth construction of deep engineering.

The distributed optical fiber monitoring system for failure monitoring of a deep rock mass provided by the present disclosure has the following parameters: spatial distance resolution as low as below 1 m, identifiable signal frequency range of 1 to 2000 Hz, capacity determined by the multi-channel optical fiber sensing conditioner 4, internal storage currently up to 4 TB, and external storage increasable unlimitedly. Therefore, the present disclosure can achieve long-term monitoring.

The present disclosure is only presented for the purpose of illustrating the description of various embodiments of the present disclosure and is not intended to be exhaustive or limited to the disclosed embodiments. Many modifications and variations will be obvious to those skilled in the art without departing from the scope and spirit of the described embodiments. Compared with technologies on the market, the terms used in the present disclosure can best explain the principles, practical applications, or technical progress of the embodiments, or enable other technicians in the field to understand the embodiments disclosed in the present disclosure.

In the present disclosure, various embodiments of the present disclosure may be presented in the form of ranges. It should be understood that the description in the form of ranges is only for convenience and conciseness and should not be construed as a hard constraint on the scope of the present disclosure. Therefore, the description of a range should be considered as specifically disclosing all possible subranges and individual numerical values within the range. For example, the description of a range such as from 1 to 6 should be considered as specifically disclosing subranges, such as from 1 to 3, from 1 to 4, from 1 to 5, from 2 to 4, from 2 to 6, from 3 to 6, and individual numerical values within the range, such as 1, 2, 3, 4, 5, 6, regardless of the width of the range.

It should be understood that, for clarity, certain features of the present disclosure described in the context of separate embodiments may also be provided in combination in a single embodiment. Conversely, for brevity, various features of the present disclosure described in the context of a single embodiment may also be provided separately or in any suitable subcombination, or in any other described embodiments of the present disclosure as appropriate. Unless the embodiment does not work without those features, certain features described in the context of various embodiments are not considered essential features of those embodiments.

All publications, patents, and patent applications mentioned in the present disclosure are incorporated into the present disclosure by reference in their entirety, to the extent as if each individual publication, patent, or patent application is specifically and individually indicated to be incorporated by reference. In addition, the citation or identification of any reference in the present disclosure should not be construed as an admission that such reference is available as prior art to the present disclosure. As for the use of section headings, the section headings should not be construed as necessary limitations.

What is claimed is:

1. A distributed optical fiber monitoring system for failure monitoring of a deep rock mass, comprising: a first optical fiber, wherein the first optical fiber is deployed on a chamber wall of an underground chamber along an axial direction of the underground chamber;
the distributed optical fiber monitoring system further comprises a second optical fiber; and the second optical fiber comprises a peripheral optical fiber segment and a direction-changing transition segment;
the peripheral optical fiber segment is deployed on the chamber wall along a cross-sectional profile of the chamber wall;
there are at least two peripheral optical fiber segments deployed at an interval along the axial direction of the underground chamber; and the peripheral optical fiber segments are sequentially connected end to end through the direction-changing transition segment to enable a continuous optical path for the second optical fiber;
the first optical fiber and/or the second optical fiber are optically connected to an integrated optical fiber sensor configured to acquire a failure signal in a key monitoring area; and the integrated optical fiber sensor comprises a deformable body, a third optical fiber, and a vibration transmission assembly;
the third optical fiber comprises a first optical fiber segment and a second optical fiber segment that communicate with each other;
the first optical fiber segment is disposed on a circumferential wall of the deformable body, and is spirally wound around an axial direction of the deformable body for at least one circle to form a first optical fiber coil;
the second optical fiber segment comprises a straight segment disposed on the circumferential wall of the deformable body along the axial direction of the deformable body; there are at least two straight segments uniformly distributed around a circumferential direction of the deformable body; and the straight segments are sequentially connected end to end through an arc-shaped direction-changing segment to form a second optical fiber coil with a continuous optical path; and
the vibration transmission assembly is disposed at a bottom of the deformable body, and is configured to transmit a vibration generated by a rock mass failure to the deformable body.

2. The distributed optical fiber monitoring system for failure monitoring of the deep rock mass according to claim 1, wherein the chamber wall comprises a left chamber wall, a top chamber wall, and a right chamber wall; and
there are more than three first optical fibers, comprising: at least one first optical fiber deployed on the left chamber wall, at least one first optical fiber deployed on the top chamber wall, and at least one first optical fiber deployed on the right chamber wall.

3. The distributed optical fiber monitoring system for failure monitoring of the deep rock mass according to claim 2, wherein there are six first optical fibers, wherein
one of the six first optical fibers is deployed on the left chamber wall and located at a position of a ⅓ height of the left chamber wall;
one of the six first optical fibers is deployed on the left chamber wall and located at a position of a ⅔ height of the left chamber wall;
one of the six first optical fibers is deployed on the top chamber wall and located at a position of a ⅓ arc length of the top chamber wall;
one of the six first optical fibers is deployed on the top chamber wall and located at a position of a ⅔ arc length of the top chamber wall;
one of the six first optical fibers is deployed on the right chamber wall and located at a position of a ⅓ height of the right chamber wall; and
one of the six first optical fibers is deployed on the right chamber wall and located at a position of a ⅔ height of the right chamber wall.

4. The distributed optical fiber monitoring system for failure monitoring of the deep rock mass according to claim 1, further comprising: a multi-channel optical fiber sensing conditioner and a data processing terminal, wherein
one end of the first optical fiber and one end of the second optical fiber each are configured to extend to an excavation face of the underground chamber and each are provided with a light extinction device;
the other end of the first optical fiber and the other end of the second optical fiber each are optically connected to the multi-channel optical fiber sensing conditioner through a lead-out optical fiber deployed along a wall surface of a shaft; and
the multi-channel optical fiber sensing conditioner is communicatively connected to the data processing terminal.

5. The distributed optical fiber monitoring system for failure monitoring of the deep rock mass according to claim 4, wherein the vibration transmission assembly comprises a rigid transmission plate and a rigid vibration ball;
one side surface of the rigid transmission plate is attached to a bottom surface of the deformable body;
the rigid vibration ball is disposed on the other side surface of the rigid transmission plate; and there are at least three rigid vibration balls distributed in a circular array with an extension line of an axis of the deformable body as an array centerline.

6. The distributed optical fiber monitoring system for failure monitoring of the deep rock mass according to claim 4, wherein the integrated optical fiber sensor further comprises a protective housing, an optical fiber guide tube, and a rock mass coupling component;
the deformable body is cylindrical;
the protective housing is covered outside the deformable body; and a bottom of the vibration transmission assembly is at least partially exposed outside the protective housing;
the optical fiber guide tube comprises an inner guide tube and an outer guide tube; the inner guide tube is inserted into the protective housing along the axial direction of the deformable body; and the outer guide tube is disposed outside the protective housing, and an opening of a partial tube segment of the outer guide tube is connected to an opening at an end of the inner guide tube;
the third optical fiber further comprises an incoming optical fiber segment and an outgoing optical fiber segment; a tail end of the incoming optical fiber segment enters the optical fiber guide tube from an opening at one end of the outer guide tube, exits from a side of the inner guide tube, and is connected to a head end of the first optical fiber segment; and a head end of the outgoing optical fiber segment is connected to a tail end of the second optical fiber segment, and a tail end of the outgoing optical fiber segment enters the optical fiber guide tube from the side of the inner guide tube and exits from an opening at the other end of the outer guide tube; and
the rock mass coupling component is disposed at the bottom of the vibration transmission assembly, and is configured to be coupled with a rock mass.

7. The distributed optical fiber monitoring system for failure monitoring of the deep rock mass according to claim 6, wherein the rock mass coupling component is a coupling cone; and a bottom surface of the coupling cone is connected to the bottom of the vibration transmission assembly.

8. The distributed optical fiber monitoring system for failure monitoring of the deep rock mass according to claim 6, wherein the rock mass coupling component comprises a coupling base and a coupling connector;
one side surface of the coupling base is attached to the bottom of the vibration transmission assembly;
the coupling connector is disposed on the coupling base, and at least a part of a connection portion of the coupling connector penetrates from the other side surface of the coupling base; and
there are at least three coupling connectors distributed in a circular array with an extension line of an axis of the deformable body as an array centerline.

9. The distributed optical fiber monitoring system for failure monitoring of the deep rock mass according to claim 2, further comprising: a multi-channel optical fiber sensing conditioner and a data processing terminal, wherein
one end of the first optical fiber and one end of the second optical fiber each are configured to extend to an excavation face of the underground chamber and each are provided with a light extinction device;
the other end of the first optical fiber and the other end of the second optical fiber each are optically connected to the multi-channel optical fiber sensing conditioner through a lead-out optical fiber deployed along a wall surface of a shaft; and
the multi-channel optical fiber sensing conditioner is communicatively connected to the data processing terminal.

10. The distributed optical fiber monitoring system for failure monitoring of the deep rock mass according to claim 9, wherein the vibration transmission assembly comprises a rigid transmission plate and a rigid vibration ball;
one side surface of the rigid transmission plate is attached to a bottom surface of the deformable body;
the rigid vibration ball is disposed on the other side surface of the rigid transmission plate;
and there are at least three rigid vibration balls distributed in a circular array with an extension line of an axis of the deformable body as an array centerline.

11. The distributed optical fiber monitoring system for failure monitoring of the deep rock mass according to claim 9, wherein the integrated optical fiber sensor further comprises a protective housing, an optical fiber guide tube, and a rock mass coupling component;
the deformable body is cylindrical;
the protective housing is covered outside the deformable body; and a bottom of the vibration transmission assembly is at least partially exposed outside the protective housing;
the optical fiber guide tube comprises an inner guide tube and an outer guide tube; the inner guide tube is inserted into the protective housing along the axial direction of the deformable body; and the outer guide tube is disposed outside the protective housing, and an opening of a partial tube segment of the outer guide tube is connected to an opening at an end of the inner guide tube;
the third optical fiber further comprises an incoming optical fiber segment and an outgoing optical fiber segment; a tail end of the incoming optical fiber segment enters the optical fiber guide tube from an opening at one end of the outer guide tube, exits from a side of the inner guide tube, and is connected to a head end of the first optical fiber segment; and a head end of the outgoing optical fiber segment is connected to a tail end of the second optical fiber segment, and a tail end of the outgoing optical fiber segment enters the optical fiber guide tube from the side of the inner guide tube and exits from an opening at the other end of the outer guide tube; and
the rock mass coupling component is disposed at the bottom of the vibration transmission assembly, and is configured to be coupled with a rock mass.

12. The distributed optical fiber monitoring system for failure monitoring of the deep rock mass according to claim 11, wherein the rock mass coupling component is a coupling cone;
and a bottom surface of the coupling cone is connected to the bottom of the vibration transmission assembly.

13. The distributed optical fiber monitoring system for failure monitoring of the deep rock mass according to claim 11, wherein the rock mass coupling component comprises a coupling base and a coupling connector;
one side surface of the coupling base is attached to the bottom of the vibration transmission assembly;
the coupling connector is disposed on the coupling base, and at least a part of a connection portion of the coupling connector penetrates from the other side surface of the coupling base; and
there are at least three coupling connectors distributed in a circular array with an extension line of an axis of the deformable body as an array centerline.

14. The distributed optical fiber monitoring system for failure monitoring of the deep rock mass according to claim 3, further comprising: a multi-channel optical fiber sensing conditioner and a data processing terminal, wherein
one end of the first optical fiber and one end of the second optical fiber each are configured to extend to an excavation face of the underground chamber and each are provided with a light extinction device;
the other end of the first optical fiber and the other end of the second optical fiber each are optically connected to the multi-channel optical fiber sensing conditioner through a lead-out optical fiber deployed along a wall surface of a shaft; and
the multi-channel optical fiber sensing conditioner is communicatively connected to the data processing terminal.

15. The distributed optical fiber monitoring system for failure monitoring of the deep rock mass according to claim 14, wherein the vibration transmission assembly comprises a rigid transmission plate and a rigid vibration ball;
one side surface of the rigid transmission plate is attached to a bottom surface of the deformable body;
the rigid vibration ball is disposed on the other side surface of the rigid transmission plate; and there are at least three rigid vibration balls distributed in a circular array with an extension line of an axis of the deformable body as an array centerline.

16. The distributed optical fiber monitoring system for failure monitoring of the deep rock mass according to claim 14, wherein the integrated optical fiber sensor further comprises a protective housing, an optical fiber guide tube, and a rock mass coupling component;
the deformable body is cylindrical;
the protective housing is covered outside the deformable body; and a bottom of the vibration transmission assembly is at least partially exposed outside the protective housing;
the optical fiber guide tube comprises an inner guide tube and an outer guide tube; the inner guide tube is inserted into the protective housing along the axial direction of the deformable body; and the outer guide tube is disposed outside the protective housing, and an opening of a partial tube segment of the outer guide tube is connected to an opening at an end of the inner guide tube;
the third optical fiber further comprises an incoming optical fiber segment and an outgoing optical fiber segment; a tail end of the incoming optical fiber segment enters the optical fiber guide tube from an opening at one end of the outer guide tube, exits from a side of the inner guide tube, and is connected to a head end of the first optical fiber segment; and a head end of the outgoing optical fiber segment is connected to a tail end of the second optical fiber segment, and a tail end of the outgoing optical fiber segment enters the optical fiber guide tube from the side of the inner guide tube and exits from an opening at the other end of the outer guide tube; and
the rock mass coupling component is disposed at the bottom of the vibration transmission assembly, and is configured to be coupled with a rock mass.

17. The distributed optical fiber monitoring system for failure monitoring of the deep rock mass according to claim 16, wherein the rock mass coupling component is a coupling cone; and a bottom surface of the coupling cone is connected to the bottom of the vibration transmission assembly.

18. The distributed optical fiber monitoring system for failure monitoring of the deep rock mass according to claim 16, wherein the rock mass coupling component comprises a coupling base and a coupling connector;
one side surface of the coupling base is attached to the bottom of the vibration transmission assembly;
the coupling connector is disposed on the coupling base, and at least a part of a connection portion of the coupling connector penetrates from the other side surface of the coupling base; and
there are at least three coupling connectors distributed in a circular array with an extension line of an axis of the deformable body as an array centerline.
